(19) United States
(12) Patent Application Publication
(10) Pub. No.: US 2024/0291612 A1
(43) Pub. Date: Aug. 29, 2024

(54) METHODS, DEVICES, AND COMPUTER READABLE MEDIUM FOR COMMUNICATION

(71) Applicant: NEC CORPORATION, Tokyo (JP)

(72) Inventors: Gang WANG, Beijing (CN); Yukai GAO, Beijing (CN)

(21) Appl. No.: 18/686,615

(22) PCT Filed: Aug. 27, 2021
(86) PCT No.: PCT/CN2021/115142

§ 371 Date: Feb. 26, 2024

(51) Int. Cl. H04L 5/00; H04L 41/16

(52) U.S. Cl. CPC H04L 5/0048; H04L 41/16

(57) ABSTRACT

Embodiments of the present disclosure relate to methods, devices, and computer readable medium for communication. According to embodiments of the present disclosure, a terminal device transmits its capability related to an artificial intelligence (AI) data processing model to a network device. The network device transmits to the terminal device a first reference signal configuration which is used during an first phase of the AI data processing model. The terminal device determines an association between the first reference signal configuration and a second reference signal configuration which is used during a training phase of the AI data processing model. In this way, the AI/ML techniques are integrated with CSI framework. Further, the terminal device understands when the reduced reference signals are used and perform corresponding behaviors.

### TECHNICAL FIELD

Embodiments of the present disclosure generally relate to the field of telecommunication, and in particular, to methods, devices, and computer readable medium for communication.

### BACKGROUND

In radio systems, multiple-input and multiple-output (MIMO) is a method for multiplying the capacity of a radio link using multiple transmission and receiving antennas to exploit multipath propagation. Moreover, artificial intelligence (AI) or machine learning (ML) for MIMO is a hot topic.

### SUMMARY

In general, example embodiments of the present disclosure provide a solution for communication.

In a first aspect, there is provided a method for communication. The communication method comprises: transmitting, at a terminal device and to a network device, first information indicating a capability of a terminal device related to an artificial intelligence (AI) data processing model; receiving, from the network device, a first reference signal configuration which is used during a first phase of the AI data processing model; and determining an association between the first reference signal configuration and a second reference signal configuration which is used during a training phase of the AI data processing model.

In a second aspect, there is provided a terminal device. The terminal device comprises a processing unit; and a memory coupled to the processing unit and storing instructions thereon, the instructions, when executed by the processing unit, causing the terminal device to perform acts comprising: transmitting, at a terminal device and to a network device, first information indicating a capability of a terminal device related to an artificial intelligence (AI) data processing model; receiving, from the network device, a first reference signal configuration which is used during a first phase of the AI data processing model; and determining an association between the first reference signal configuration and a second reference signal configuration which is used during a training phase of the AI data processing model.

In a third aspect, there is provided a computer readable medium having instructions stored thereon, the instructions, when executed on at least one processor, causing the at least one processor to carry out the method according to any one of the first aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates a signaling flow for training and applying a data processing model according to conventional technologies;

FIG. 2 is a schematic diagram of a communication environment in which embodiments of the present disclosure can be implemented;

FIG. 3 illustrates a signaling flow for communications according to some embodiments of the present disclosure;

FIG. 4 shows an example framework for the AI data processing model;

FIG. 5 illustrates a signaling flow for CSI-RS transmissions according to some embodiments of the present disclosure;

FIGS. 6A-6C show configurations in the frequency-domain according to some embodiments of the present disclosure;

FIG. 7 shows a configuration in the antenna-port-domain according to some embodiments of the present disclosure;

FIG. 8 shows a configuration in the antenna-port-domain according to some embodiments of the present disclosure;

FIG. 9 shows a time domain reference point according to some embodiments of the present disclosure;

FIG. 10 is a flowchart of an example method in accordance with an embodiment of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies.

The term “circuitry” used herein may refer to hardware circuits and/or combinations of hardware circuits and software. For example, the circuitry may be a combination of analog and/or digital hardware circuits with software/finrmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, AI/ML techniques are applied to MIMO scenario. For example, the AI/ML can be applied in one or more of the following cases: demodulation reference signal (DMRS) demodulation, channel state information (CSI) feedback, beam management or reference signal (RS) overhead reduction.

Conventionally, channel state information reference signal (CSI-RS) can be used for different functionalities, such as channel acquisition, beam management, tracking, or mobility. CSI-RS in principle is UE-specific RS, which means system RS overhead is propositional to the number of UEs. In frequency range (FR) 2, CSI-RS is required for different beams, which means system RS overhead is propositional to the number of beams. In high speed scenario, periodicity of CSI-RS is quite small, which means very frequent CSI-RS transmission and report.

In higher layer framework, for each CSI report, resources for measurements are configured in hierarchical structure. The hierarchical structure can be as: report configuration→resource configuration→resource set→resource. The report configuration can define when/what/how UE should report for CSI. One UE can be configured with multiple report configurations. One report configuration can be linked to one or more multiple resource configurations. The resource configuration can be linked to one or more resource sets via a resource set list. A resource set may contain information of one or more multiple resources via a resource list. A resource is the minimum unit for physical layer configurations of CSI-RS.

As discussed above, AI/ML techniques can be applied. The term “Artificial Intelligence (AI)” can be intelligence demonstrated by machines. The term “Machine learning (ML)” used herein can refer to the study of computer algorithms that can improve automatically through experience and by the use of data. It is seen as a part of artificial intelligence. Machine learning algorithms build a model based on sample data, known as “training data”, in order to make predictions or decisions without being explicitly programmed to do so.

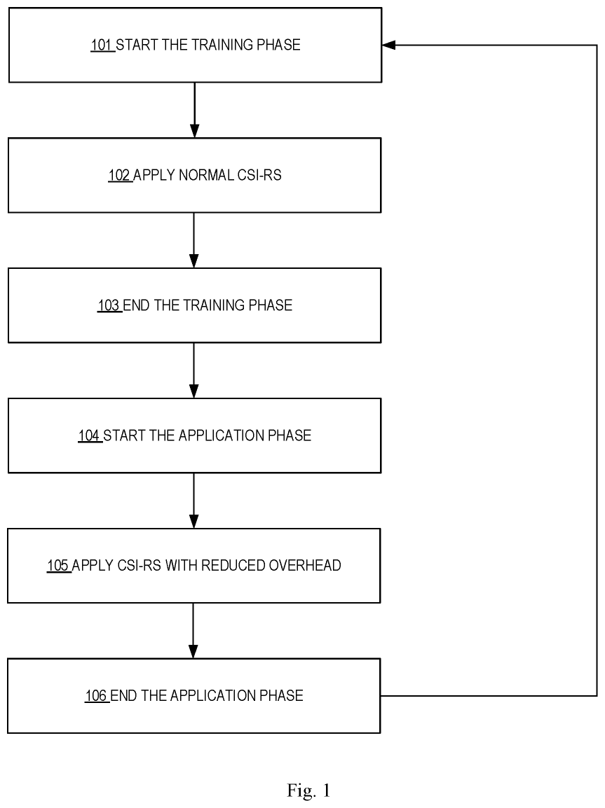

If the AI/ML technique is used to reduce CSI-RS overheads, it can be split into at least two phases, for example, a training phase and an application phase. During the training phase, the AI/ML model can collect training data in order to make predictions of the CSI-RS. During the application phase, the AI/ML model can collect inference data and execute inference output. The output from the first phase can also contribute to training data. In some embodiments, normal CSI-RS can be applied during the training phase and CSI-RS with reduced overheads can be applied during the application phase. Alternatively, the normal CSI-RS can be applied during the first phase and increased CSI-RS (for example, more CSI-RS transmissions in a certain domain) can be applied during the training phase. FIG. 1 shows an example flowchart of the AI/ML procedure. The AI/ML model can start (101) the training phrase. During the training phase, the normal CSI-RS is applied (102). The AI/ML model can end (103) the training phase and start (104) the application phase. During the application phase, the CSI-RS with reduced overheads is applied (105). The AI/ML model can end (106) the first phase and the output from the first phase can be further used during the training phase.

Further, in order to reduce CSI-RS overhead, 4 different scenarios can be identified, and it is possible to have combinations of different scenarios, for example, scenario 1: CSI-RS time-domain overhead reduction; scenario 2: CSI-RS frequency-domain overhead reduction; scenario 3: CSI-RS antenna-port-domain overhead reduction; scenario 4: CSI-RS beam-domain overhead reduction. There are some issues need to be addressed in order to support the CSI-RS with reduced overhead. For example, it is not clear how to integrate AI/ML model training phase and AI/ML model first phase in CSI framework. How to measure other gNB/UE interference if other gNB/UE is in AI/ML model first phase with less or no transmission needs to be studied. It also needs to be studied on multiplexing with other physical channels/signals and definition of UE measurement.

Therefore, new solutions on applying AI/ML in reference signals are applied. According to embodiments of the present disclosure, a terminal device transmits its capability related to a AI data processing model to a network device. The network device transmits to the terminal device a first reference signal configuration which is used during an first phase of the AI data processing model. The terminal device determines an association between the first reference signal configuration and a second reference signal configuration which is used during a training phase of the AI data processing model. In this way, the AI/ML techniques are integrated with CSI framework. Further, the terminal device understands when the reduced reference signals are used and perform corresponding behaviors.

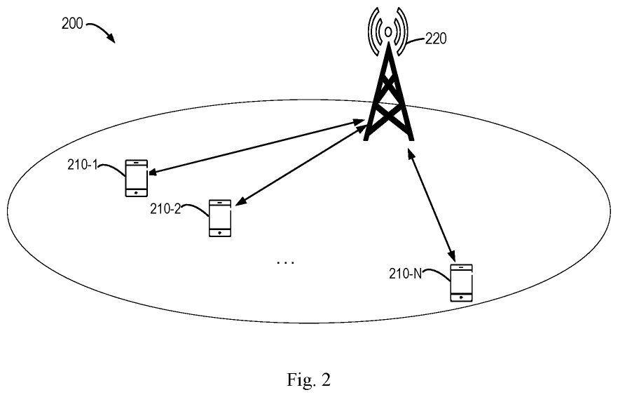

FIG. 2 illustrates a schematic diagram of a communication system in which embodiments of the present disclosure can be implemented. The communication system 200, which is a part of a communication network, comprises a terminal device 210-1, a terminal device 210-2, . . . , a terminal device 210-N, which can be collectively referred to as “terminal device(s) 210.” The number N can be any suitable integer number.

The communication system 200 further comprises a network device 220. In the communication system 200, the network devices 220 and the terminal devices 210 can communicate data and control information to each other. The numbers of terminal devices and network devices shown in FIG. 2 are given for the purpose of illustration without suggesting any limitations.

Communications in the communication system 200 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

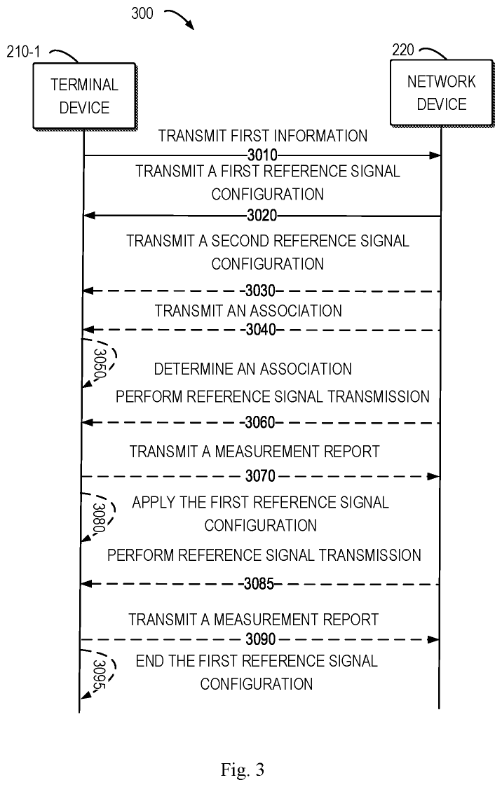

Embodiments of the present disclosure will be described in detail below. Reference is first made to FIG. 3, which shows a signaling chart illustrating process 300 between the terminal device and the network device according to some example embodiments of the present disclosure. Only for the purpose of discussion, the process 300 will be described with reference to FIG. 2. The process 300 may involve the terminal device 210-1 and the network device 220 in FIG. 2.

The terminal device 210-1 may transmit 3010 first information indicating its capability related to a AI data processing model. There are several algorithms can be applied to the AI data processing model, for example, Linear Regression, Logistic Regression, Linear Discriminant Analysis, Classification and Regression Trees, Naive Bayes, K-Nearest Neighbors (KNN), Learning Vector Quantization (LVQ), and Support Vector Machine (SVM). It should be noted that other algorithms can also be applied to the AI data processing model. The capability can be transmitted via any proper signaling, for example, RRC signaling.

The term “AI data processing model” used herein can refer to a data driven algorithm or a model by applying such as artificial intelligence, machine learning, deep learning, rapid machine learning, Heterogeneous mixture learning, invariant analysis, text entailment recognition techniques that generates a set of outputs consisting of predicted information, based on a set of inputs. The AI data processing model comprises a training phase and a first phase. In some embodiments, the AI data processing model is mentioned as the only one model that throughout each phase, comprising first phase, application phase, training phase and other phases such as testing phase. In some embodiments, the first phase can refer to an application phase. Alternatively, the first phase can refer to an inference phase. The term “training phase” used herein can refer to an online or offline process to train an AI data processing model by learning features and patterns that best present data and get the trained AI data processing model for inference. In some embodiments, the training phase can be mentioned as an second phase. The term “application phase” or “inference phase” used herein can refer to a process of using a trained AI data processing model to make a prediction or guide the decision based on collected data and AI data processing model.

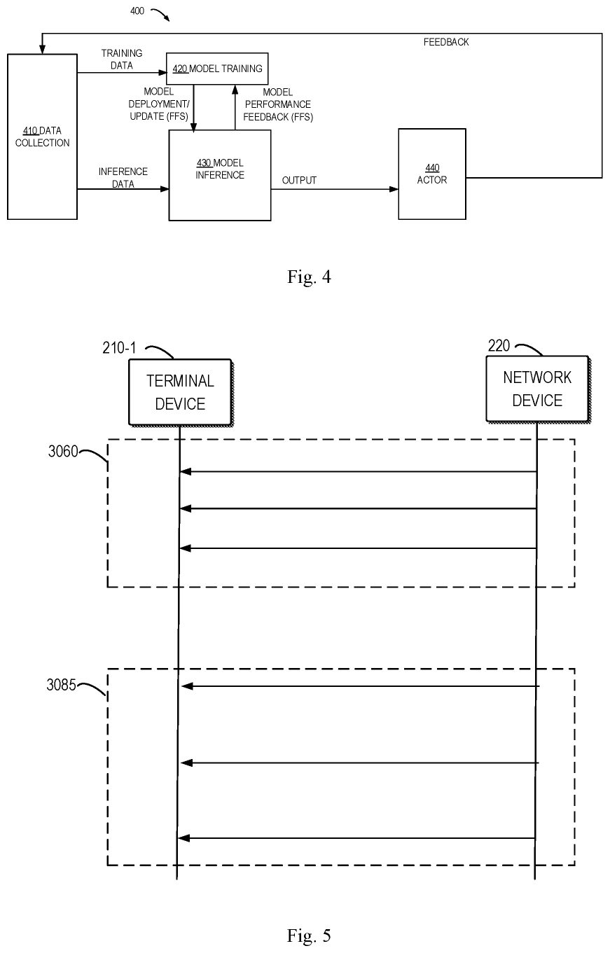

FIG. 4 shows an example framework for the AI data processing model. As shown in FIG. 4, the framework 400 of the AI data processing model can comprise a data collection module 410, a model training module 420, a model inference module 430 and an actor module 440. The data collection module 410 can provide input data to the model training module 420 and the model inference module 430. AI/ML algorithm specific pre-processing of data is not carried out in the data collection module 410. Examples of input data may include measurements from UEs or different network entities, performance feedback, AI/ML model output. Training Data can refer to information needed for the AI/ML model training function. Inference Data can refer to information needed as an input for the Model inference function to provide a corresponding output. Feedback can refer to information that may be needed to derive training or inference data or performance feedback.

The model training module 420 can perform the training of the AI data processing model. The model training module 420 is also responsible for data preparation (e.g. data pre-processing and cleaning, formatting, and transformation of raw data), if required. The model inference module 430 can provide AI/ML model inference output (e.g. predictions or decisions). The model inference module 430 is also responsible for data preparation (e.g. data pre-processing and cleaning, formatting, and transformation of raw data), if required. The actor module 440 can receive the output from the model inference module 430 and trigger or perform corresponding actions. The actor module 440 may trigger actions directed to other entities or to itself.

In some embodiments, the capability can indicate whether the terminal device 210-1 can train the AI data processing model independently. The capability may also indicate whether the terminal device 210-1 can train the AI data processing model jointly with the network device 220. Alternatively or in addition, the capability can indicate whether the terminal device 210-1 can infer information with the AI data processing model. For example, the information can comprise one or more of: beam information, CSI information, timing synchronization information, or frequency synchronization information. In other embodiments, the capability can indicate the processing time to infer the output. In some embodiments, the capability can indicate the processing time to act based on the inference output. The above capabilities may be common to CSI-RS overhead reductions in time domain, frequency domain, antenna port domain and beam domain.

The capability may indicate whether the terminal device 210-1 can support time domain CSI-RS overhead reduction. Alternatively or in addition, the capability may indicate whether the terminal device 210-1 can support frequency domain CSI-RS overhead reduction. In other embodiments, the capability can also indicate the antenna-port CSI-RS overhead reduction. The capability may indicate the beam domain CSI-RS overhead reduction.

In some embodiments, the capability may indicate the maximum supported number of reduced CSI report configurations during the first phase of the AI data processing model. The capability may also indicate the maximum supported number of reduced CSI resource configurations during the first phase of the AI data processing model. Alternatively or in addition, the capability may indicate the maximum supported number of reduced CSI resource sets during the first phase of the AI data processing model. In other embodiments, the capability may indicate the maximum supported number of reduced CSI resources during the first phase of the AI data processing model.

Referring back to FIG. 3, the network device 220 transmits 3020 a first reference signal configuration to the terminal device 210-1. The first reference signal configuration is used during the first phase of the AI data processing model. The first reference signal configuration may be determined based on UE reported or recommended values. The number of the first reference signal configurations are not counted in UE reported maximum supported number of reference signal configurations.

In some embodiments, the first reference signal configuration may be a report configuration (which can be represented as “CSI-ReportConfig”). In this case, the first reference signal configuration can be used to configure a periodic or semi-persistent report sent on physical uplink control channel (PUCCH) on the cell in which the CSI-ReportConfig is included, or to configure a semi-persistent or aperiodic report sent on physical uplink shared channel (PUSCH) triggered by downlink control information (DCI) received on the cell in which the CSI-ReportConfig is included (in this case, the cell on which the report is sent is determined by the received DCI).

In some embodiments, the first reference signal configuration may be a resource configuration. For example, the resource configuration may define a group of one or more non-zero power (NZP) CSI-RS-ResourceSet, CSI-IM-ResourceSet and/or CSI-synchronization signal block (SSB)-ResourceSet. The IE CSI-SSB-ResourceSet is used to configure one synchronization signal/physical broadcast channel (SS/PBCH) block resource set which refers to SS/PBCH as indicated in ServingCellConfigCommon. The IE NZP-CSI-RS-ResourceSet is a set of Non-Zero-Power (NZP) CSI-RS resources (their IDs) and set-specific parameters. The IE CSI-IM-ResourceSet is used to configure a set of one or more CSI Interference Management (IM) resources (their IDs) and set-specific parameters. Alternatively or in addition, the first reference signal configuration may be a resource set configuration.

In some embodiments, the network device 220 may transmit 3030 a second reference signal configuration to the terminal device 210-1. The second reference signal configuration can be used during the training phase of the AI data processing model. In some embodiments, the network device 220 may transmit the first reference signal configuration, in accordance with an association between the first reference signal configuration and the second reference signal configuration.

The terminal device 210-1 determines an association between the first reference signal configuration and the second reference signal configuration. In some embodiments, determining the association may comprise receiving the association from the network. For example, the terminal device 210-1 may receive the explicit association from the network device 220. Alternatively, the terminal device 210-1 may determine the association without explicit signaling. Details are described later.

In some embodiments, the first reference signal configuration may comprise a first identity associated with the first phase of the AI data processing model and the second reference signal configuration may comprise a second identity associated with the training phase of the AI data processing model. In this case, the network device 220 may transmit 3040 second information indicating an association between the first reference signal configuration and the second reference signal configuration. The second information can be transmitted via any proper signaling. In some embodiments, there can be one to one mapping between the first reference signal configuration and the second reference signal configuration. Alternatively or in addition, there can be one to many, many to one, or many to many mapping between reference signal configurations for the first phase and reference signal configurations for the training phase. The first reference signal configuration may comprise lower values parameters than the second reference signal configuration. Table 1 below shows a mapping between the first reference signal configuration and the second reference signal configuration.

TABLE 1

| | The second reference | The first reference | |
|---|---|---|---|
| | signal configuration | signal configuration | |
| Configuration | with a second identity | with a first identity | |
| level | (ID X) | (ID Y) | Action/impact |
| ReportConfig | With ReportConfig | With ReportConfig ID | ReportConfig/ |
| | ID X | Y | ResourceConfig/ |
| ResourceConfig | With ResourceConfig | With ResourceConfig | ResourceSet/ |
| | ID X | ID Y | Resource with ID Y is |
| ResourceSet | With ResourceSet ID | With ResourceSet ID | used to replace |
| | X | Y | the associated |
| Resource | With Resource ID X | With Resource ID Y | one with ID X in |
| | | | AI/ML model |
| | | | application phase |

In some embodiments, the network device 220 may transmit the first reference signal configuration and the second reference signal configuration in a same reference signal configuration. In this case, the reference signal configuration may comprise multiple values for one parameter and the lower values are applied during the first phase of the AI data processing model. For example, the reference signal configuration may comprise a first set of values for a set of parameters and a second set of values for the set of parameters. The first set of values are lower than the second set of values. The terminal device 210-1 may determine 3050 the association between the first reference signal configuration and the second reference signal configuration. The association may be implicitly indicated. For example, the terminal device 210-1 may determine that the first reference signal configuration comprises the first set of values and the second reference signal configuration comprises the second set of values. The set of parameters can comprises one or more of parameters in time-domain, parameters in frequency-domain, parameters in antenna-port-domain and parameters in beam-domain. Table 2 shows an example of multiple values configured for one parameter.

TABLE 2

| | Possible | | | |
|---|---|---|---|---|
| | parameter | | | |
| | (example, | | | |
| | more in | | Associated | |
| | detailed page | | CSI-RS with | |
| | for each | Normal | additional | |
| Scenarios | scenario) | CSI-RS | value | |
| Time-domain | resourceType | With value | With value B | For |
| | | A, e.g. | <A, e.g. | configuration |
| | | Periodic | Aperiodic | parameters, |
| Frequency-domain | Frequency | With value | With value B | Value B is |
| used to | density | A, e.g. 3 | <A, e.g. 1 | |
| Antenna-port-domain | Number of | With value | With value B | |
| | ports | A, e.g. 32 | <A, e.g. 4 | |
| Beam-domain | Number of | With value | With value B | |
| | resources in a | A, e.g. 64 | <A, e.g. 8 | |
| | set for beam | | | |
| | measurement | | | |

During the training phase of the AI data processing model, the network device 220 can perform 3060 the reference signal transmission. For example, the reference signal transmission can be performed based on the second reference signal configuration. In this training phase, the first reference signal configuration can be invalid/deactivated and the associated second reference signal configuration can be valid/activated.

The terminal device 210-1 may measure the reference signals received from the network device 220. The terminal device 210-1 may transmit 3070 a measurement report based on the reference signals from the network device 220.

During the first phase of the AI data processing model, the terminal device 210-1 may apply 3080 the first reference signal configuration. In this application phase, the first reference signal configuration can be valid/activated and the associated second reference signal configuration can be invalid/deactivated.

In some embodiments, the network device 220 may transmit, to the terminal device 210-1, a start indication to apply the first reference signal configuration. The start indication can be dedicated for informing the start of the first phase of the AI data processing model.

Alternatively, the start indication can be a legacy indication which is also used for other functionality. For example, the network device 220 may transmit a CSI-RS activation command to activate the first reference signal configuration, meanwhile, to deactivate the second reference signal configuration.

In other embodiments, the start indication may be dynamic signaling to inform UE the new applied values for related parameters. The related parameters may be different in each scenario. In some embodiments, application timing can be considered, for example, X time units after the start indication or after ACK of the start indication.

In some embodiments, the terminal device 210-1 may request to start applying the first reference signal configuration. For example, if a condition for applying the first reference signal configuration is met, the terminal device 210-1 may transmit a start request to apply the first reference signal configuration to the network device 220. In some embodiments, the condition can be that predicted values from the AI data processing model outputs are close to measured values. For example, the condition can comprise a difference between an output from the AI data processing model and a measured value is below a threshold. In this case, the network device 220 may transmit the start indication to the terminal device 210-1 based on the start request. After receiving the start indication from the network device 220, the terminal device 210-1 may apply the first reference signal configuration. In this case, application timing can be considered, for example, X time units after the start request/start indication or after ACK of the start request/start indication. Alternatively, the terminal device 210-1 may apply the first reference signal configuration according to configured timing information, for example, periodicity, duty cycle, time-domain pattern, and the like.

During the first phase of the AI data processing model, the network device 220 can perform 3085 the reference signal transmission. For example, the reference signal transmission can be performed based on the first reference signal configuration.

The terminal device 210-1 may measure the reference signals received from the network device 220. The terminal device 210-1 may transmit 3090 a measurement report based on the reference signals from the network device 220 and/or the inference outputs from AI data processing model.

The terminal device 210-1 may end 3095 the application of the first reference signal configuration. In some embodiments, the network device 220 may transmit, to the terminal device 210-1, an end indication to end the application of the first reference signal configuration. The end indication can be dedicated for informing the end of the first phase of the AI data processing model.

Alternatively, the end indication can be a legacy indication which is also used for other functionality. For example, the network device 220 may transmit a CSI-RS deactivation command to deactivate the first reference signal configuration, meanwhile, to activate the second reference signal configuration.

In other embodiments, the end indication may be dynamic signaling to inform UE the new applied values for related parameters. The related parameters may be different in each scenario. In some embodiments, application timing can be considered, for example, X time units after the end indication or after ACK of the end indication.

In some embodiments, the terminal device 210-1 may request to end the application of the first reference signal configuration. For example, if a condition for ending the application of the first reference signal configuration is met, the terminal device 210-1 may transmit an end request to stop application of the first reference signal configuration to the network device 220. In some embodiments, the condition can be that predicted values from the AI data processing model outputs are significantly different from measured values. For example, the condition can comprise a difference between an output from the AI data processing model and a measured value exceeds a threshold. In this case, the network device 220 may transmit the end indication to the terminal device 210-1 based on the end request. After receiving the end indication from the network device 220, the terminal device 210-1 may stop applying the first reference signal configuration. In this case, application timing can be considered, for example, X time units after the end request/end indication or after ACK of the end request/end indication. Alternatively, the terminal device 210-1 may stop applying the first reference signal configuration according to configured timing information, for example, priority, duty cycle, time-domain pattern, and the like.

Embodiments of the capability related to the AI data processing model and the first and second reference signal configuration are described with the reference to FIGS. 5-8. Only for the purpose of illustrations, embodiments of the present disclosure are described with the reference to CSI-RS.

In some embodiments, the capability may relate to the time-domain and the first and second reference signal configurations can comprise parameters in the time-domain. For example, the capability may indicate that the terminal device 210-1 can support the first phase of the AI data processing model for X time units, or for duty cycle [X %]. The capability can indicate that the terminal device 210-1 can support a larger periodicity for reduced CSI-RS as [2, 4, 8, . . . ] times of the periodicity of associated CSI-RS. The capability can indicate whether the terminal device 210-1 can support aperiodic CSI-RS as reduced CSI-RS. The capability can indicate whether the terminal device 210-1 can support no CSI-RS in the first phase of the AI data processing model. In this case, according to the first reference signal transmission, the reduced CSI-RS can be transmitted with less time-domain occupancies, e.g., with a larger periodicity, becomes aperiodic, or even no transmission. Additionally, the non-periodic time domain pattern can be used, which means more complicated signaling, e.g., CSI-RS would be transmitted on [t1, t2, . . . , tN], where ti is timing index. For example, as shown in FIG. 5, during the training phase, the network device 220 may perform 3060 the reference signal transmissions. During the application, the network device 220 may perform 3085 the reference signal transmission. As illustrated in FIG. 5, the period between two reference signals in the first phase is longer than the period between two reference signals in the training phase. Table 3 shows example reference signal configurations in time-domain.

TABLE 3

| | | Normal | Reduced |
|---|---|---|---|
| Configuration level | Possible parameters | CSI-RS | CSI-RS |
| ReportConfig | reportConfigType | Periodic | Aperiodic, or |
| | | | semiPersistent |
| ReportConfig | CSI-ReportPeriodicity AndOffset | X slots | Y < X slots |
| ResourceConfig | resourceType | Periodic | Aperiodic, or |
| | | | semi Persistent |
| ResourceSet | periodicity AndOffset | X slots | Y < X slots |

In some embodiments, the capability may relate to the frequency-domain and the first and second reference signal configurations can comprise parameters in the frequency-domain. For example, the capability may indicate a frequency occupancy range where the terminal device 210-1 can perform inference, e.g., ±X MHz/RBG/RB in the first phase of the AI data processing model. The capability can indicate that the terminal device 210-1 can support minimum frequency density X when associated CSI-RS is with density Y Additionally or alternatively, the capability can indicate the minimum number of resource blocks (RBs) for CSI-RS transmission in the first phase of the AI data processing model. The capability can indicate whether the terminal device 210-1 can support no CSI-RS in the first phase of the AI data processing model. The capability can also indicate whether the terminal device 210-1 can support CSI-RS transmitted on other carrier component (CC)/carrier/cell/bandwidth part (BWP) in the first phase of the AI data processing model. In this case, the terminal device 210-1 can indicate the reference CC such that CSI-RS transmitted on the CC can be used as the reduced CSI-RS for other CCs. The terminal device 210-1 can report whether PCell, SPCell, or cell with lowest/highest ID can be the reference CC. Alternatively, the terminal device 210-1 can report the grouping information such that CSI-RS transmitted on one CC in the group can be used as the reduced CSI-RS for other CCs in the group. In other embodiments, the terminal device 210-1 can report whether CSI-RS transmitted on one CC can be used as reduced CSI-RS on the other CC via bitmap. According to the first reference signal configuration, the reduced CSI-RS can be transmitted with less frequency-domain occupancies than the second reference signal configuration.

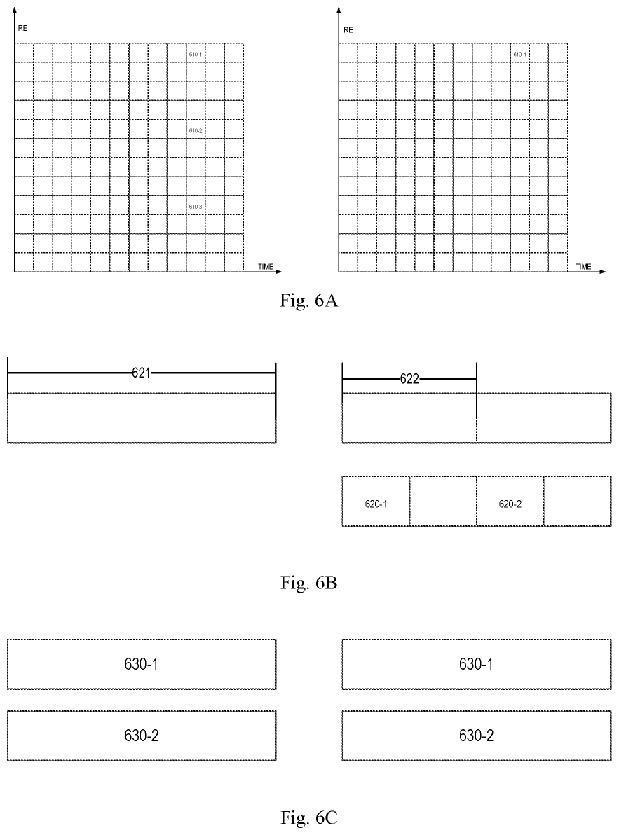

In some embodiments, as shown in FIG. 6A, according to the second reference signal configuration, the normal CSI-RS can be 1-port with density 3Res (for example, RE 610-1, RE 610-2 and RE 610-3). According to the first reference signal configuration, the reduced CSI-RS can be 1-port with density 1 RE (for example, RE 610-1) which is a lower density.

In other embodiments, as shown in FIG. 6B, according to the second reference signal configuration, the normal CSI-RS can be configured with a start RB and a first number of RBs. For example, the normal CSI-RS can be transmitted over RBs 621. The reduced CSI-RS can be configured with the start RB and a second number of RBs. The second number is smaller than the first number. For example, the reduced CSI-RS can span over less RBs. For example, the reduced CSI-RS can be transmitted over RBs 622. Alternatively, discontinuous RB occupancy can be configured. For example, the reduced CSI-RS can transmit only on selected RBs, for example, the RB 620-1 and the RB 620-2.

Alternatively, as shown in FIG. 6C, the normal CSI-RS can be transmitted on the CC 630-1 and CC 630-2, according to the second reference signal configuration. The reduced CSI-RS can be transmitted on one CC, for example, the CC 630-1.

Table 4 shows example reference signal configurations in frequency-domain.

TABLE 4

| | Possible | | |
|---|---|---|---|
| Configuration level | parameters | Normal CSI-RS | Reduced CSI-RS |
| ReportConfig | Carrier | X | Y |
| ResourceConfig | BWP | X | Y |
| ResourceSet/Resource | Density | X | Y < X |
| ResourceSet/Resource | freqBand | X | Y < X |
| ResourceSet/Resource | nrofRBs | X | Y < X |

In some embodiments, the capability may relate to the antenna-port-domain and the first and second reference signal configurations can comprise parameters in the antenna-port-domain. In some embodiments, the capability can indicate antenna port grouping information from the terminal device side. The capability may indicate that the terminal device 210-1 can support minimum number of ports X when associated CSI-RS is with Y ports. Additionally, the capability can indicate which ports can be used in the first phase of the AI data processing model. In this case, according to the first reference signal configuration, the reduced CSI-RS can be transmitted with less antenna ports for channel measurement and/or for interference measurement. In addition, port compression matrix/vector C, conversion relationship from W′ to W, can be signaled to the terminal device 210-1. For example, in the first phase of the AI data processing model, CSI-RS can be only transmitted via a subset of ports, then only H′ can be estimated where H′ represents the channel for P′-port CSI-RS. For PDSCH transmission, transmission layers are experiencing H*W, which corresponds to interference as H*W*X, where H represents the channel for P-port CSI-RS, W represents the precoding matrix estimated by H.

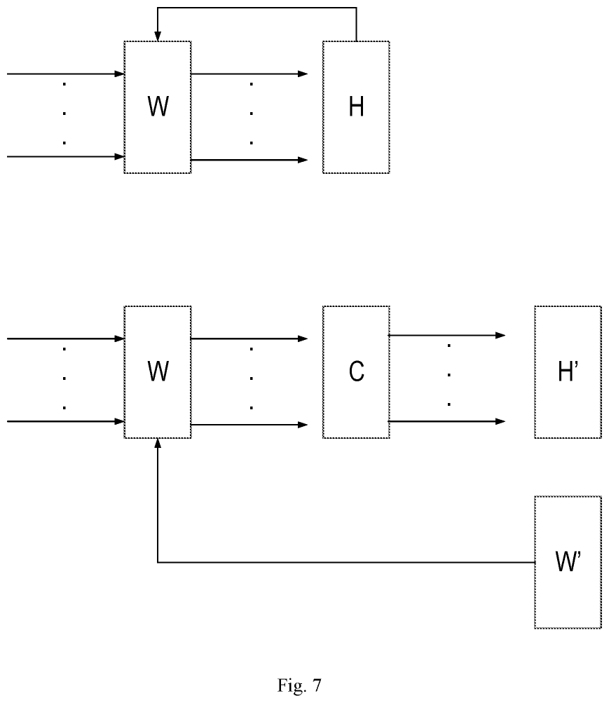

As shown in FIG. 7, the normal CSI measurement can be to compute W by measuring H, where W represents the precoding matrix estimated by H and H represents the channel for P-port CSI-RS. The reduced CSI measurement can determine a suitable port compression matrix to reduce CSI-RS transmission from P ports to P′ ports can be to compute W by measuring H′, for example, computing W by W′, where W represents the precoding matrix estimated by H, H′ represents the channel for P′-port CSI-RS, and W′ represents the precoding matrix estimated by H′.

Table 5 shows example reference signal configurations in antenna-port-domain.

TABLE 5

| Configuration level | Possible parameters | Normal CSI-RS | Reduced CSI-RS |
|---|---|---|---|
| ReportConfig | RI restriction | X | Y |
| ReportConfig | Codebooksubset | X | Y |
| | restriction | | |
| ResourceSet/Resource | nrofPorts (for both | X | Y < X |
| | channel | | |
| | measurement and | | |
| | interference | | |
| | measurement) | | |
| ResourceSet/Resource | portIndex1, | X | Y |
| | portIndex2, | | |
| | portIndex4, | | |
| | portIndex8, . . . | | |
| | (port indexes for at | | |
| | least one of the | | |
| | ranks) | | |

In some embodiments, the capability may relate to the beam-domain and the first and second reference signal configurations can comprise parameters in the beam-domain. In some embodiments, the capability can indicates the number of resources for beam management in the first phase of the AI data processing model. The number of resources for beam management can be respective for layer 1 reference signal received power (L1-RSRP), for layer 1 signal interference noise ratio (L1-SINR), for beam failure detection, for new beam identification. The number of resources for beam management in the first phase of the AI data processing model can be [½, ¼, ⅛, . . . ] of the number of resources for beam management in the training phase of the AI data processing model. The capability may indicate the maximum number receiving beams in the first phase of the AI data processing model. In this case, according to the first reference signal configuration, the reduced CSI-RS can be transmitted with less beams than the second reference signal configuration.

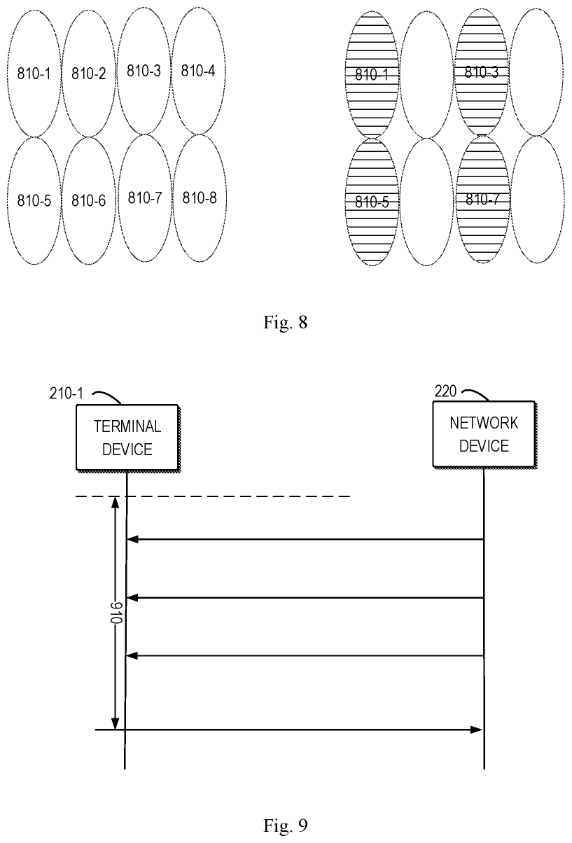

As shown in FIG. 8, according to the second reference signal configuration, the normal CSI-RS can be transmitted on the beams 810-1, 810-2, 810-3, 810-4, 810-5, 810-6, 810-7 and 810-8. According to the first reference signal configuration, the reduced CSI-RS can be transmitted on beams 810-1, 810-3, 810-5 and 810-7.

Table 6 shows example reference signal configurations in beam-domain.

TABLE 6

| Configuration | Possible | | |
|---|---|---|---|
| level | parameters | Normal CSI-RS | Reduced CSI-RS |
| ReportConfig | Size of | X | Y < X |
| | ResourceConfigList | | |
| ResourceConfig | Size of | X | Y < X |
| | ResourceSetList | | |
| ResourceSet | Size of | X | Y < X |
| | ResourceList | | |

In some embodiments, the terminal device 210-1 may receive third information from the network device 220. The third information indicates a compensation factor of interference power during the first phase of the AI data processing model. In some embodiments, the compensation factor of interference power during the first phase of the AI data processing model and another compensation factor of interference power during the training phase of the AI data processing model can be configured respectively. For example, when the terminal device 210-1 may compute channel quality indicator (CQI) or L1-SINR, the interference power may be measured power on CSI-IM resource plus the configured compensation factor.

Additionally, implicitly, the value of compensation factor may depend on different parameters in different scenarios. For example, regarding frequency-domain, the value of compensation factor may depend on a ratio between transmission RBs of two associated CSI-IM. Regarding antenna-port-domain, the value of compensation factor may depend on a ratio between the number of full ports and the number of subset of ports. In this case, the network device 220 needs to transmit information about other UEs to the terminal device 210-1. Alternatively or in addition, regarding the beam-domain, the value of compensation factor may depend on a ratio between the number of full beams and the number of subset of beams. In this way, to align the interference situation in real data transmission and in CSI-RS measurement time period, it improves the performance of the AI data processing model and improves the performance for those terminal devices not supporting AI/ML.

During the first phase of the AI data processing model, only those REs carrying reduced CSI-RS should be considered as ‘not available’ for other channels/signals like PDSCH, PDCCH, DMRS, PTRS, etc. In other embodiments, a first priority of CSI-RS during the first phase of the AI data processing model can be lower than a second priority of CSI-RS during the training phase of the AI data processing model. For example, during the first phase of the AI data processing model, the CSI-RS may not be transmitted on symbols or REs if there is PDSCH/PDCCH transmission on those symbols/REs. In this case, the corresponding CSI report can be dropped. In this way, it achieves more REs for data transmission with the help from AI/ML capability. Table 7 shows an example of PDSCH mapping.

TABLE 7
the corresponding resource elements in the corresponding physical resource blocks are
not used for transmission of the associated DM-RS or DM-RS intended for other
co-scheduled UEs as described in clause 7.4.1.1.2;
not used for non-zero-power CSI-RS according to clause 7.4.1.5 if the corresponding
physical resource blocks are for PDSCH scheduled by PDCCH with CRC scrambled by
C-RNTI, MCS-C-RNTI, CS-RNTI, or PDSCH with SPS, except if the non-zero-power
CSI-RS is a CSI-RS configured by the higher-layer parameter CSI-RS-Resource-Mobility
in the MeasObjectNR IE or except if the non-zero-power CSI-RS is an aperiodic
non-zero-power CSI-RS resource or except if the non-zero-power CSI-RS is in AI/ML
model application phase;
not used for PT-RS according to clause 7.4.1.2;
not declared as ‘not available for PDSCH according to clause 5.1.4 of [6, TS 38.214].

In some embodiments, the terminal device 210-1 may exclude a set of occasions from a measurement of CSI-RS during the first phase of the AI data processing model. In the application phase, reduced CSI-RS can be transmitted, compare with normal CSI-RS configured, some occasions/REs are not with actually transmitted signal and should be excluded from UE measurement of CSI-RSRP/RSRQ/SINR. For example, during the application phase, only REs with actually transmitted signal should be used from UE measurement of CSI-RSRP/RSRQ/SINR. The term “CSI reference signal received power (CSI-RSRP)” used herein can be defined as the measured/inferred linear average over the power contributions (in [W]) of the resource elements of the antenna port(s) that carry CSI reference signals configured/transmitted for RSRP measurements within the considered measurement frequency bandwidth in the configured/transmitted CSI-RS occasions. For CSI-RSRP determination CSI reference signals transmitted on antenna port 3000 according to TS 38.211 shall be used. If CSI-RSRP is used for L1-RSRP, CSI reference signals transmitted on antenna ports 3000, 3001 can be used for CSI-RSRP determination. For intra-frequency CSI-RSRP measurements, if the measurement gap is not configured and AI/ML model first phase is not activated, UE is not expected to measure the CSI-RS resource(s) outside of the active downlink bandwidth part. For frequency range 1, the reference point for the CSI-RSRP shall be the antenna connector of the UE. For frequency range 2, CSI-RSRP shall be measured based on the combined signal from antenna elements corresponding to a given receiver branch. For frequency range 1 and 2, if receiver diversity is in use by the UE, the reported CSI-RSRP value shall not be lower than the corresponding CSI-RSRP of any of the individual receiver branches.

The term “CSI signal-to-noise and interference ratio (CSI-SINR)” used herein can be defined as the measured/inferred linear average over the power contribution (in [W]) of the resource elements carrying CSI reference signals divided by the linear average of the noise and interference power contribution (in [W]). If CSI-SINR is used for L1-SINR reporting with dedicated interference measurement resources, the interference and noise is measured over resource(s) indicated by higher layers as described in TS 38.214. Otherwise, the interference and noise are measured over the resource elements carrying CSI reference signals within the same frequency bandwidth. For CSI-SINR determination CSI reference signals transmitted on antenna port 3000 according to TS 38.211 shall be used. If CSI-SINR is used for L1-SINR, CSI reference signals transmitted on antenna ports 3000, 3001 can be used for CSI-SINR determination. For intra-frequency CSI-SINR measurements not used for L1-SINR reporting, if the measurement gap is not configured and AI/ML model first phase is not activated, UE is not expected to measure the CSI-RS resource(s) outside of the active downlink bandwidth part. For frequency range 1, the reference point for the CSI-SINR shall be the antenna connector of the UE. For frequency range 2, CSI-SINR shall be measured based on the combined signal from antenna elements corresponding to a given receiver branch. For frequency range 1 and 2, if receiver diversity is in use by the UE, the reported CSI-SINR value shall not be lower than the corresponding CSI-SINR of any of the individual receiver branches.

Alternatively, the terminal device 210-1 may determine a time domain reference point for generating a CSI report based on the capability of the terminal device 210-1. For example, during the first phase of the AI data processing model, the time domain reference point can be determined by AI/ML processing capability. For CSI report in uplink slot n′, the terminal device 210-1 could drop the report if n−n_{AI/MI-ref}>=X, where n_{AI/ML-ref} is starting DL slot of AI/ML first phase and X is UE reported capability. The terminal device 210-1 may be configured about whether to generate CSI report based on AI/ML model inference only, or based on measurement of reduced CSI-RS only, or based on both. The terminal device 210-1 may also report to the network device 220 the information regarding generating the CSI report based on AI/ML model inference only, or based on measurement of reduced CSI-RS only, or based on both. As shown in FIG. 9, the CSI-RS within the duration 910 can be used for the CSI report. In this way, it can support CSI report when CSI-RS with time-domain overhead reduction is used in AI/ML application phase.

In some embodiments, the terminal device 210-1 may determine a CSI computation delay requirement based on the AI data processing model. For example, in the first phase of the AI data processing mode, for one CSI report, the channel acquisition can occupy 0 or 1 CSI processing unit (CPU). If occupied CPU is 1, the number of occupied symbols is from CSI reference resource to CSI report. During the first phase of the AI data processing model, the delay requirement (for example, the PDCCH to CSI report repot time and the CSI-RS to CSI report time) may have a longer requirement considering interface between the AI/ML entity and the communication entity. Alternatively, during the first phase of the AI data processing model, the delay requirement (for example, the PDCCH to CSI report repot time and the CSI-RS to CSI report time) may have a shorter requirement if the AI/ML model inference is embedded. In this case, in some embodiments, the delay requirement can be as fast as same-slot feedback. Values of the delay requirement may be reported from the terminal device 210-1 to the network device 220. Alternatively, the values of the delay requirement may be pre-defined.

In some embodiments, during the application phase of the AI data processing model, the reduce CSI with less frequency occupancies can have power boosting. For example, for CQI computation, the assumed ratio of PDSCH Energy Per Resource Element (EPRE) to NZP CSI-RS EPRE can be powerControlOffset−10*log 10(X/Y), where Y is frequency density of reduced CSI-RS and X is frequency density of the associated CSI-RS resource. The assumed ratio of PDSCH EPRE to NZP CSI-RS EPRE can be powerControlOffset−10*log 10(X/Y), where Y is the number of RBs of reduced CSI-RS and X is the number of RBs of the associated CSI-RS resource. In addition, for L1-RSRP/SINR computation, the assumed ratio of NZP CSI-RS EPRE to SS/PBCH block EPRE can be powerControlOffset+10*log 10(X/Y), where Y is frequency density of reduced CSI-RS and X is frequency density of the associated CSI-RS resource. The assumed ratio of NZP CSI-RS EPRE to SS/PBCH block EPRE can be powerControlOffset+10*log 10(X/Y), where Y is the number of RBs of reduced CSI-RS and X is the number of RBs of the associated CSI-RS resource.

In other embodiments, the terminal device 210-1 may determine a minimum of a CSI-RS bandwidth during the application phase of the AI data processing model based on a capacity reporting of the terminal device 210-1. For example, the terminal device 210-1 shall expect that N_{CSI-RS}^{BW}≥min(X, N_{BWP}^{size}), where X is UE reported value.

Alternatively or in addition, the terminal device 210-1 may determine a CQI based on the number of CSI-RS ports configured in an associated CSI-RS resource during the training phase of the AI data processing model. For example, for CQI calculation, the terminal device 210-1 may assume that PDSCH signals on antenna ports in the set [1000, . . . , 1000+v−1] for v layers would result in signals equivalent to corresponding symbols transmitted on antenna ports [3000, . . . , 3000+P−1], as given by

$$[ \begin{matrix}{y}^{( 3000 )} ( i ) \\ … \\ {y}^{( 3000 + P - 1 )} ( i )\end{matrix} ] = W ( i ) [ \begin{matrix}{x}^{( 0 )} ( i ) \\ … \\ {x}^{( v - 1 )} ( i )\end{matrix} ] ,$$

where P represents the number of CSI-RS ports configured in associated CSI-RS resource. In this way, it can correct the mismatch between reduced CSI-RS transmission and real data transmission.

In some embodiments, during the application phase of the AI data processing model, the terminal device 210-1 may determine a CSI-RS resource indicator based on the number of CSI-RS resources in a resource set for training the AI data processing model. During the application phase of the AI data processing model, CRI bitwidth can be determined as [log₂(Kₛ^{CSI-RS})] where Kₛ^{CSI-RS} is the number of CSI-RS resources in the associated resource set in AI/ML model training phase. In this way, it provides a method to report select beam which is not with transmitted CSI-RS.

In other embodiments, the terminal device 210-1 may use associated CSI-RS periodicity to determine a beam failure instance indication (BFII) report time in the first phase of the AI data processing model. For example, during the first phase of the AI data processing model, the terminal device 210-1 may determine the BFII periodicity based on an associated reference signal during the training phase of the AI data processing model. In some embodiments, the terminal device 210-1 may determine a beam reference signal based on the associated reference signal during the training phase of the AI data processing model. Alternatively, an explicit periodicity of BFII can used for BFII report, e.g., every X ms. The periodicity can be configured by the network, based on UE capability.

Alternatively, during the first phase of the AI data processing model, the terminal device 210-1 can directly declare beam failure without counting the number of BFII. For example, a new indication from UE PHY to UE higher layer or from AI/ML model host to UE higher layer can be introduced to trigger beam failure recovery request transmission. In AI/ML model application phase, in non-discontinuous reception (DRX) mode operation, the physical layer in the UE provides an indication to higher layers when the radio link quality for all corresponding resource configurations in the set q0 that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the associated SS/PBCH blocks on the PCell or the PSCell and/or the associated periodic CSI-RS configurations in the set q0 that the UE uses to assess the radio link quality and 2 msec. In DRX mode operation, the physical layer provides an indication to higher layers when the radio link quality is worse than the threshold Q_{out,LR} with a periodicity determined as described in [10, TS 38.133].

In some embodiments, the terminal device 210-1 may use an associated candidate beam detection (CBD) RS set in the training phase of the AI data processing model to identify that the new beam in the first phase of the AI data processing model and random access channel (RACH) CBD RS association is the same in the training phase and the first phase of the AI data processing model. For example, if at least one of the SSBs with measured/inferred SS-RSRP above rsrp-ThresholdSSB amongst the SSBs in associated candidateBeamRSList or the CSI-RSs with measured/inferred CSI-RSRP above rsrp-ThresholdCSI-RS amongst the CSI-RSs in associated candidateBeamRSList is available, the terminal device 210-1 can select an SSB with measured/inferred SS-RSRP above rsrp-ThresholdSSB amongst the SSBs in associated candidateBeamRSList or a CSIRS with measured/inferred CSI-RSRP above rsrp-ThresholdCSI-RS amongst the CSI-RSs in associated candidateBeamRSList.

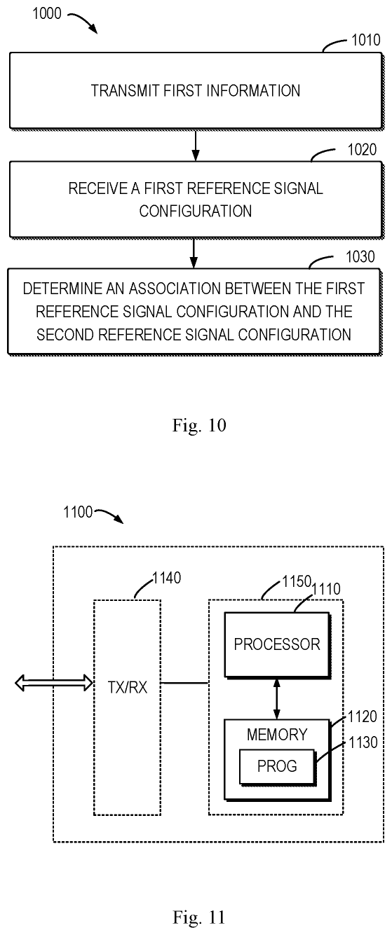

FIG. 10 shows a flowchart of an example method 1000 in accordance with an embodiment of the present disclosure. The method 1000 can be implemented at any suitable devices. Only for the purpose of illustrations, the method 1000 can be implemented at a terminal device 210-1 as shown in FIG. 2.

At block 1010, the terminal device 210-1 transmits, to the network device 220, first information. The first information indicates a capability of a terminal device related to a machine learning (AI) data processing model.

At block 1020, the terminal device 210-1 receives, from the network device 220, a first reference signal configuration which is used during an first phase of the AI data processing model.

In some embodiments, the terminal device 210-1 may receive a channel state information reference signal (CSI RS) configuration from the network device. The CSI RS configuration comprises a first set of values for a set of parameters associated with the first phase of the AI data processing model and a second set of values for the set of parameters associated with the training phase of the AI data processing model. The first set of values being can be lower than the second set of values. In this case, the terminal device 210-1 may determine first reference signal configuration which comprises the first set of values.

At block 1030, the terminal device 210-1 determines an association between the first reference signal configuration and a second reference signal configuration. The second reference signal configuration is used during a training phase of the AI data processing model.

In some embodiments, the terminal device 210-1 may receive the second reference signal configuration from the network device 220. The first reference signal configuration comprises a first identity associated with the first phase of the AI data processing model, and the second reference signal configuration comprises a second identity associated with the training phase of the AI data processing model.

In some embodiments, the terminal device 210-1 may receive, from the network device 220, second information indicating the association. In this case, the terminal device 210-1 may determine the association based on the second information.

In some embodiments, the terminal device 210-1 may receive, from the network device 220, a start indication to apply the first reference signal configuration. The terminal device 210-1 may apply the first reference signal configuration based on the start indication during the first phase of the AI data processing model.

In some embodiments, if a condition for applying the first reference signal configuration is met, the terminal device 210-1 may transmit, to the network device 220, a start request to apply the first reference signal configuration. The condition may comprise a difference between an output from the AI data processing model and a measured value is below a threshold value. The terminal device 210-1 may receive, from the network device 220, a start indication to apply the first reference signal configuration. The terminal device 210-1 may apply the first reference signal configuration.

In some embodiments, the terminal device 210-1 may receive, from the network device 220, an indication to end an application of the first reference signal configuration. The terminal device 210-1 may cause an end of the application of the first reference signal configuration based on the indication.

In some embodiments, if a condition for ending an application of the first reference signal configuration is met, the terminal device 210-1 may cause an end of the application of the first reference signal configuration. The condition may comprise a difference between an output from the AI data processing model and a measured value exceeds the threshold value.

In some embodiments, the first information comprises a capability for time-domain. In some embodiments, the capability for time-domain indicates at least one of: a support of an application of the first reference signal configuration for a predetermined time period or a duty cycle, a support of a periodicity of channel state information reference signal (CSI RS), whether the terminal device supports aperiodic CSI RS, or whether the terminal device supports no CSI RS during the first phase of the AI data processing model.

In some embodiments, the first reference signal configuration comprises a time-domain configuration, and the time-domain configuration indicates a transmission of channel state information reference signal (CSI RS) with less time-domain occupancies than the second reference signal configuration.

In some embodiments, the first information comprises a capability for frequency-domain, and the capability for frequency-domain indicates at least one of: a frequency occupancy range where the terminal device is able to perform inference, a support of a minimum frequency density, a minimum number of resource blocks for a transmission of channel state information reference signal (CSI RS) during the first phase of the AI data processing model, whether the terminal device supports no CSI RS during the first phase of the AI data processing model, or whether the terminal device supports a transmission of the CSI RS on a carrier during the first phase of the AI data processing model.

In some embodiments, the first reference signal configuration comprises a frequency-domain configuration, and the frequency-domain configuration indicates a transmission of channel state information reference signal (CSI RS) with less frequency-domain occupancies than the second reference signal configuration.

In some embodiments, the first information comprises a capability for antenna-port-domain, and the capability for antenna-port-domain indicates at least one of: a minimum number of antenna ports, or which antenna port is used during the first phase of the AI data processing model.

In some embodiments, the first reference signal configuration comprises a antenna-port-domain configuration, and the antenna-port-domain configuration indicates a transmission of channel state information reference signal (CSI RS) with less antenna-port-domain occupancies than the second reference signal configuration.

In some embodiments, the first information comprises a capability for beam-domain, and the capability for beam-domain indicates at least one of: the number of resource for beam management during the first phase of the data processing model, or a maximum number of receiving beams during the first phase of the AI data processing model.

In some embodiments, the first reference signal configuration comprises a beam-domain configuration, and the beam-domain configuration indicates a transmission of channel state information reference signal with less beam-domain occupancies than the second reference signal configuration.

In some embodiments, the terminal device 210-1 may receive, from the network device 220, third information indicating a compensation factor of interference power during the first phase of the AI data processing model.

In some embodiments, a first priority of channel state information reference signal during the first phase of the AI data processing model is lower than second priority of channel state information reference signal during the training phase of the AI data processing model.

In some embodiments, the terminal device 210-1 may exclude a set of occasions from a measurement of channel state information reference signal during the first phase of the AI data processing model.

In some embodiments, the terminal device 210-1 may determine a time domain reference point for generating CSI report based on the capability of the terminal device.

In some embodiments, the terminal device 210-1 may generate a channel state information (CSI) report based on an inference of the AI data processing model. In other embodiments, the terminal device 210-1 may generate the CSI report based on a measurement of the CSI RS. Alternatively, the terminal device 210-1 may generate the CSI report based on the inference of the AI data processing model and the measurement of the CSI RS.

In some embodiments, the terminal device 210-1 may determine a CSI computation delay requirement based on the AI data processing model. In some embodiments, the terminal device 210-1 may determine a minimum of a channel state information reference signal (CSI RS) bandwidth during the first phase of the AI data processing model based on a capacity reporting of the terminal device.

In some embodiments, the terminal device 210-1 may determine a channel quality indicator based on the number of channel state information reference signal (CSI RS) ports configured in an associated CSI RS resource during the training phase of the AI data processing model. In some embodiments, during the first phase of the AI data processing model, the terminal device 210-1 may determine a CSI RS resource indicator based on the number of CSI RS resources in an associated resource set in the training phase of the AI data processing model.

In some embodiments, during the first phase of the AI data processing model, the terminal device 210-1 may determine a beam failure instance indication periodicity based on an associated reference signal during the training phase of the AI data processing model.

In some embodiments, the terminal device 210-1 may determine a beam reference signal based on the associated reference signal during the training phase of the AI data processing model.

In some embodiments, a terminal device comprises circuitry configured to transmit, to a network device, first information indicating a capability of a terminal device related to a machine learning (AI) data processing model; receive, from the network device, a first reference signal configuration which is used during an first phase of the AI data processing model; and determine an association between the first reference signal configuration and a second reference signal configuration which is used during a training phase of the AI data processing model.

In some embodiments, the terminal device comprises circuitry configured to receive the second reference signal configuration from the network device; and wherein the first reference signal configuration comprises a first identity associated with the first phase of the AI data processing model, and the second reference signal configuration comprises a second identity associated with training phase the AI data processing model.

In some embodiments, the terminal device comprises circuitry configured to receive the first reference signal configuration by: receiving a channel state information reference signal (CSI RS) configuration from the network device, the CSI RS configuration comprising a first set of values for a set of parameters associated with the first phase of the AI data processing model and a second set of values for the set of parameters associated with the training phase of the AI data processing model, the first set of values being lower than the second set of values; and determining the first reference signal configuration which comprises the first set of values.

In some embodiments, the terminal device comprises circuitry configured to determine the association by: receiving, from the network device, second information indicating the association; and determining the association based on the second information.

In some embodiments, the terminal device comprises circuitry configured to receive, from the network device, a start indication to apply the first reference signal configuration; and apply the first reference signal configuration based on the start indication during the first phase of the AI data processing model.

In some embodiments, the terminal device comprises circuitry configured to receive in accordance with a determination that a condition for applying the first reference signal configuration is met, transmit, to the network device, a start request to apply the first reference signal configuration; receive, from the network device, a start indication to apply the first reference signal configuration; apply the first reference configuration; and wherein the condition comprises a difference between an output from the AI data processing model and a measured value is below a threshold value.

In some embodiments, the terminal device comprises circuitry configured to receive, from the network device, an indication to end an application of the first reference signal configuration; and cause an end of the application of the first reference signal configuration based on the indication.

In some embodiments, the terminal device comprises circuitry configured to receive in accordance with a determination that a condition for ending an application of the first reference signal configuration is met, cause an end of the application of the first reference signal configuration; and wherein the condition comprises a difference between an output from the AI data processing model and a measured value exceeds the threshold value.

In some embodiments, the first information comprises a capability for time-domain, and wherein the capability for time-domain indicates at least one of: a support of an application of the first reference signal configuration for a predetermined time period or a duty cycle, a support of a periodicity of channel state information reference signal (CSI RS), whether the terminal device supports aperiodic CSI RS, or whether the terminal device supports no CSI RS during the first phase of the AI data processing model.

In some embodiments, the first reference signal configuration comprises a time-domain configuration, and wherein the time-domain configuration indicates a transmission of channel state information reference signal (CSI RS) with less time-domain occupancies than the second reference signal configuration.

In some embodiments, the first information comprises a capability for frequency-domain, and wherein the capability for frequency-domain indicates at least one of: a frequency occupancy range where the terminal device is able to perform inference, a support of a minimum frequency density, a minimum number of resource blocks for a transmission of channel state information reference signal (CSI RS) during the first phase of the AI data processing model, whether the terminal device supports no CSI RS during the first phase of the AI data processing model, or whether the terminal device supports a transmission of the CSI RS on a carrier during the first phase of the AI data processing model.

In some embodiments, the first reference signal configuration comprises a frequency-domain configuration, and wherein the frequency-domain configuration indicates a transmission of channel state information reference signal (CSI RS) with less frequency-domain occupancies than the second reference signal configuration.

In some embodiments, the first information comprises a capability for antenna-port-domain, and wherein the capability for antenna-port-domain indicates at least one of: a minimum number of antenna ports, or which antenna port is used during the first phase of the AI data processing model.

In some embodiments, the first reference signal configuration comprises a antenna-port-domain configuration, and wherein the antenna-port-domain configuration indicates a transmission of channel state information reference signal (CSI RS) with less antenna-port-domain occupancies than the second reference signal configuration.

In some embodiments, the first information comprises a capability for beam-domain, and wherein the capability for beam-domain indicates at least one of: the number of resource for beam management during the first phase of the data processing model, or a maximum number of receiving beams during the first phase of the AI data processing model.

In some embodiments, the first reference signal configuration comprises a beam-domain configuration, and wherein the beam-domain configuration indicates a transmission of channel state information reference signal with less beam-domain occupancies than the second reference signal configuration.

In some embodiments, the terminal device comprises circuitry configured to receive, from the network device, third information indicating a compensation factor of interference power during the first phase of the AI data processing model.

In some embodiments, a first priority of channel state information reference signal during the first phase of the AI data processing model is lower than second priority of channel state information reference signal during the training phase of the AI data processing model.

In some embodiments, the terminal device comprises circuitry configured to exclude a set of occasions from a measurement of channel state information reference signal during the first phase of the AI data processing model.

In some embodiments, the terminal device comprises circuitry configured to determine a time domain reference point for generating CSI report based on the capability of the terminal device.

In some embodiments, the terminal device comprises circuitry configured to generate a channel state information (CSI) report based on an inference of the AI data processing model; generate the CSI report based on a measurement of the CSI RS; or generate the CSI report based on the inference of the AI data processing model and the measurement of the CSI RS.

In some embodiments, the terminal device comprises circuitry configured to determine a CSI computation delay requirement based on the AI data processing model.

In some embodiments, the terminal device comprises circuitry configured to determine a minimum of a channel state information reference signal (CSI RS) bandwidth during the first phase of the AI data processing model based on a capacity reporting of the terminal device.

In some embodiments, the terminal device comprises circuitry configured to determine a channel quality indicator based on the number of channel state information reference signal (CSI RS) ports configured in an associated CSI RS resource during the training phase of the AI data processing model.

In some embodiments, the terminal device comprises circuitry configured to during the first phase of the AI data processing model, determine a CSI RS resource indicator based on the number of CSI RS resources in an associated resource set in the training phase of the AI data processing model.

In some embodiments, the terminal device comprises circuitry configured to during the first phase of the AI data processing model, determine a beam failure instance indication periodicity based on an associated reference signal during the training phase of the AI data processing model. Alternatively or in addition, he terminal device comprises circuitry configured to determine a beam reference signal based on the associated reference signal during the training phase of the AI data processing model.

In some embodiments, a network device comprises circuitry configured to receive, from a terminal device, first information indicating a capability of a terminal device related to a machine learning (AI) data processing model; in accordance with an association between a first reference signal configuration and a second reference signal configuration, transmit the first reference signal configuration to the terminal device, wherein the first reference signal configuration is used during a first phase of the AI data processing model and the second reference signal configuration is used during a training phase of the AI data processing model.

In some embodiments, the network device comprises circuitry configured to transmit the second reference signal configuration to the network device. The first reference signal configuration comprises a first identity associated with the first phase of the AI data processing model, and the second reference signal configuration comprises a second identity associated with the training phase of the AI data processing model.

In some embodiments, the network device comprises circuitry configured to transmit the first reference signal configuration by: transmitting a channel state information reference signal (CSI RS) configuration from the network device, the CSI RS configuration comprising a first set of values for a set of parameters associated with the first phase of the AI data processing model and a second set of values for the set of parameters associated with the training phase of the AI data processing model, the first set of values being lower than the second set of values.

FIG. 11 is a simplified block diagram of a device 1100 that is suitable for implementing embodiments of the present disclosure. The device 1100 can be considered as a further example implementation of the terminal device 210 and the network device 220 as shown in FIG. 2. Accordingly, the device 1000 can be implemented at or as at least a part of the terminal device 210 or the network device 220.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this application may have several ones.

The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIG. 3 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1550 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 4-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A communication method, comprising:
transmitting, at a terminal device and to a network device, first information indicating a capability of a terminal device related to an artificial intelligence (AI) data processing model;
receiving, from the network device, a first reference signal configuration which is used during a first phase of the AI data processing model; and
determining an association between the first reference signal configuration and a second reference signal configuration which is used during a training phase of the AI data processing model.

2. The method of claim 1, further comprising:
receiving the second reference signal configuration from the network device; and
wherein the first reference signal configuration comprises a first identity associated with the first phase of the AI data processing model, and the second reference signal configuration comprises a second identity associated with the training phase of the AI data processing model.

3. The method of claim 1, wherein receiving the first reference signal configuration comprises:
receiving a channel state information reference signal (CSI RS) configuration from the network device, the CSI RS configuration comprising a first set of values for a set of parameters associated with the first phase of the AI data processing model and a second set of values for the set of parameters associated with the training phase of the AI data processing model, the first set of values being lower than the second set of values; and
determining the first reference signal configuration which comprises the first set of values.

4. The method of claim 1, wherein determining the association comprises:
receiving, from the network device, second information indicating the association; and
determining the association based on the second information.

5. The method of claim 1, further comprising:
receiving, from the network device, a start indication to apply the first reference signal configuration; and
applying the first reference signal configuration based on the start indication during the first phase of the AI data processing model,
or
in accordance with a determination that a condition for applying the first reference signal configuration is met, transmitting, to the network device, a start request to apply the first reference signal configuration;
receiving, from the network device, a start indication to apply the first reference signal configuration;
applying the first reference configuration; and
wherein the condition comprises a difference between an output from the AI data processing model and a measured value is below a threshold value.

6. (canceled)

7. The method of claim 5, further comprising:
receiving, from the network device, an indication to end an application of the first reference signal configuration; and
causing an end of the application of the first reference signal configuration based on the indication.

8. The method of claim 5, further comprising:
in accordance with a determination that a condition for ending an application of the first reference signal configuration is met, causing an end of the application of the first reference signal configuration; and
wherein the condition comprises a difference between an output from the AI data processing model and a measured value exceeds the threshold value.

9. The method of claim 1, wherein at least one of:
the first information comprises a capability for time-domain, and wherein the capability for time-domain indicates at least one of:
a support of an application of the first reference signal configuration for a predetermined time period or a duty cycle,
a support of a periodicity of channel state information reference signal (CSI RS),
whether the terminal device supports aperiodic CSI RS, or
whether the terminal device supports no CSI RS during the first phase of the AI data processing model;
the first information comprises a capability for frequency-domain, and wherein the capability for frequency-domain indicates at least one of:
a frequency occupancy range where the terminal device is able to perform inference,
a support of a minimum frequency density,
a minimum number of resource blocks for a transmission of channel state information reference signal (CSI RS) during the first phase of the AI data processing model,
whether the terminal device supports no CSI RS during the first phase of the AI data processing model, or
whether the terminal device supports a transmission of the CSI RS on a carrier during the first phase of the AI data processing model:
the first information comprises a capability for antenna-port-domain, and
wherein the capability for antenna-port-domain indicates at least one of:
a minimum number of antenna ports, or
which antenna port is used during the first phase of the AI data processing model;
or
the first information comprises a capability for beam-domain, and
wherein the capability for beam-domain indicates at least one of:
the number of resource for beam management during the first phase of the data processing model, or
a maximum number of receiving beams during the first phase of the AI data processing model.

10. The method of claim 1, wherein at least one of:
the first reference signal configuration comprises a time-domain configuration, and wherein the time-domain configuration indicates a transmission of channel state information reference signal (CSI RS) with less time-domain occupancies than the second reference signal configuration;
the first reference signal configuration comprises a frequency-domain configuration, and wherein the frequency-domain configuration indicates a transmission of channel state information reference signal (CSI RS) with less frequency-domain occupancies than the second reference signal configuration;
the first reference signal configuration comprises a antenna-port-domain configuration, and wherein the antenna-port-domain configuration indicates a transmission of channel state information reference signal (CSI RS) with less antenna-port-domain occupancies than the second reference signal configuration: or
the first reference signal configuration comprises a beam-domain configuration, and wherein the beam-domain configuration indicates a transmission of channel state information reference signal with less beam-domain occupancies than the second reference signal configuration.

11-16. (canceled)

17. The method of claim 1, further comprising at least one of:
receiving, from the network device, third information indicating a compensation factor of interference power during the first phase of the AI data processing model;
excluding a set of occasions from a measurement of channel state information reference signal during the first phase of the AI data processing model;
determining a time domain reference point for generating CSI report based on the capability of the terminal device;
determining a CSI computation delay requirement based on the AI data processing model; or
determining a minimum of a channel state information reference signal (CSI RS) bandwidth during the first phase of the AI data processing model based on a capacity reporting of the terminal device.

18. The method of claim 1, wherein a first priority of channel state information reference signal during the first phase of the AI data processing model is lower than second priority of channel state information reference signal during the training phase of the AI data processing model.

19-20. (canceled)

21. The method of claim 1, further comprising one of:
generating a channel state information (CSI) report based on an inference of the AI data processing model;
generating the CSI report based on a measurement of the CSI RS; or
generating the CSI report based on the inference of the AI data processing model and the measurement of the CSI RS.

22-23. (canceled)

24. The method of claim 1, further comprising:
determining a channel quality indicator based on the number of channel state information reference signal (CSI RS) ports configured in an associated CSI RS resource during the training phase of the AI data processing model.

25. The method of claim 1, further comprising:
during the first phase of the AI data processing model, determining a CSI RS resource indicator based on the number of CSI RS resources in an associated resource set in the training phase of the AI data processing model; or
during the first phase of the AI data processing model, determining a beam failure instance indication periodicity based on an associated reference signal during the training phase of the AI data processing model; or
determining a beam reference signal based on the associated reference signal during the training phase of the AI data processing model.

26. (canceled)

27. A terminal device comprising:
a processor; and
a memory coupled to the processor and storing instructions thereon, the instructions, when executed by the processor, causing the terminal device to:
transmit, to a network device, first information indicating a capability of a terminal device related to an artificial intelligence (AI) data processing model;
receive, from the network device, a first reference signal configuration which is used during a first phase of the AI data processing model; and
determine an association between the first reference signal configuration and a second reference signal configuration which is used during a training phase of the AI data processing model.

28. A communication method, comprising:
receiving, at a network device and from a terminal device, first information indicating a capability of a terminal device related to a machine learning (AI) data processing model; and
in accordance with an association between a first reference signal configuration and a second reference signal configuration, transmitting the first reference signal configuration to the terminal device, wherein the first reference signal configuration is used during a first phase of the AI data processing model and the second reference signal configuration is used during a training phase of the AI data processing model.

29. The method of claim 28, further comprising:
transmitting the second reference signal configuration to the network device; and
wherein the first reference signal configuration comprises a first identity associated with the first phase of the AI data processing model, and the second reference signal configuration comprises a second identity associated with the training phase of the AI data processing model.

30. The method of claim 28, wherein transmitting the first reference signal configuration comprises:
transmitting a channel state information reference signal (CSI RS) configuration from the network device, the CSI RS configuration comprising a first set of values for a set of parameters associated with the first phase of the AI data processing model and a second set of values for the set of parameters associated with the training phase of the AI data processing model, the first set of values being lower than the second set of values.

31. (canceled)
